(19) United States
(12) Patent Application Publication
(10) Pub. No.: US 2010/0279003 A1
(43) Pub. Date: Nov. 4, 2010

(54) Free standing nanostructured metal and metal oxide anodes for lithium-ion rechargeable batteries

(75) Inventor: Ming Au, Martinez, GA (US)

Correspondence Address: J. Bennett Mullinax;J. Bennett Mullinax, LLC, P O Box 26029, Greenville, SC, 29616-1029, US

(73) Assignee: Savannah River Nuclear Solutions, LLC, Aiken, SC (US)

(21) Appl. No.: 12/799,466

(22) Filed: Apr. 26, 2010

Related U.S. Application Data
(60) Provisional application No. 61/172,254, filed on Apr. 24, 2009.

(51) Int. Cl. H01M 4/04; B05D 5/12

(52) U.S. Cl. 427/123; 427/126.3; 427/126.6; 977/773; 977/948

(57) ABSTRACT

The nanoscale architecture of anode materials and the process for forming an anode for a lithium ion battery is provided along with an apparatus. The anodes comprise aligned nanorods of metals which are formed on metallic substrates. When used as the anodes in a lithium-ion battery, the resulting battery demonstrates higher energy storage capacity and has greater capability to accommodate the volume expansion and contraction during repeated charging and discharging.

### RELATED APPLICATIONS

This application claims the benefit of US Provisional Application No. 61/172,254, filed on Apr. 24, 2009, and which is incorporated herein by reference.

### STATEMENT AS TO RIGHTS TO INVENTIONS MADE UNDER FEDERALLY SPONSORED RESEARCH AND DEVELOPMENT

This invention was made with Government support under Contract No. DE-AC09-08SR22470 awarded by the United States Department of Energy. The Government has certain rights in the invention.

### FIELD OF THE INVENTION

This invention is directed to a new type of anodes for lithium-ion rechargeable batteries. Aligned metal nanostructures, such as free standing aluminum nanoscale column referred to as “nanorods” can be grown on metal current collectors directly as an anode without having to mix or paste binders, conductive additives and active materials together. The free standing metal nanorod anodes result in higher energy storage capacity can be made with reduced complexity compared to traditional anode fabrication, allows designs which are more resistant to redox reaction related volume expansion, and allows for more rapid charging and discharging of resulting batteries. Without using volatile organic solvents, the one-step fabrication of anodes of metal and metal oxide nanorods offers a low cost and an environmentally sound productive process benefit to battery manufacturers.

### BACKGROUND OF THE INVENTION

Conventional procedures for anode fabrication of lithium-ion carbon based anodes consists of mixing an active material such as carbon with a polymer binder and various conductive additives. Following mixing, the resulting mixed paste is cast into a current collector such as copper and then heated to remove the organic solvents. The current process limits the energy density to the percentage of active materials, such as carbon, in the paste. The polymer binders in the paste are insulators providing no conductivity for the current. The powdery active materials and conductive additive do not have the direct contact with the current collector and thereby limits the power density of the batteries.

It is known that certain metals and metal oxides, when used as the anodes, have a ten times higher theoretical energy storage capacity (such as Si) than carbon anodes used currently. However, the large volume expansion (200-300%) during charging and subsequent same volume contraction during discharge leads to material pulverization and battery failure.

Another obstacle in using free standing nanostructured anodes is the detachment of the active materials from the substrates (or electrodes) after limited charge-discharge cycles. Proper selection of the substrate is important to sustain the original high capacity. However, the prior art does not address substrate selection as an important parameter of material compatibility and stability.

Accordingly, there remains room for improvement and variation within the art.

### SUMMARY OF THE INVENTION

It is one aspect of at least one of the present embodiments to provide for an aluminum anode Li-ion rechargeable battery having a four fold higher capacity than carbon anode Li-ion rechargeable batteries.

It is another aspect of at least one of the present embodiments to provide the metal and metal oxide nanostructure of rod-like active materials that can be formed directly on a current collector and without the use of mixing and pasting of binders and conductive additives.

It is yet a further and more particular object of the present invention to provide for an anode having a rod-like nanostructure in which spaces between the rods accommodate redox reaction related volume expansion and contraction such that the metal and metal oxide nanostructured anode has lower stress and longer cycle life.

The free standing nanostructured metals and metal oxides, such as aligned nanorods and nanowires provide the opportunity to utilize metals and metal oxide as the anodes by accommodating volume changes with the spacing between nanorods and nanowires.

A further objective of at least one embodiment of the present invention is to provide selection of an appropriate substrate (electrode) selection on which the nanostructured metals and metal oxides may form. The substrate (electrode) should be chosen from the metals that can form compounds with the metals or metal oxides to be deposited as the free standing nanostructures; Ideally, metals for the substrate should have solubility for the metals or metal oxides to be deposited as the free standing nanostructures, or chosen from metals that have the same lattice pattern and similar lattice parameters as the metals or metal oxides to be deposited as the free standing nanostructures.

These and other features, aspects, and advantages of the present invention will become better understood with reference to the following description and appended claims.

### BRIEF DESCRIPTION OF THE FIGURES

FIG. 1 and FIG. 2 are scanning electron micrographs of aligned aluminum nanorods in accordance with the present invention.

FIG. 3 through FIG. 5 are graphs showing discharge capacities of Li/Al nanorods cell.

FIG. 6 is a scanning electron micrograph showing delamination of the Al nanorod from a titanium substrate following ten cycles of charge and discharge.

FIG. 7 sets forth the cycle stability of a Li/Al nanorod cell on a Cu substrate.

FIG. 8 is a scanning electron micrograph demonstrating the integrity of the Al nanorod layer on a Cu substrate following ten cycles of charge and discharge.

FIG. 9(a) and FIG. 9(b) are scanning electron micrographs of hollow nanorods of Co₃O₄ on a titanium substrate.

FIG. 10 is an x-rayed fraction analysis conforming the formation of Co₃O₄ from a titanium substrate.

FIG. 11 is a scanning electron micrograph image demonstrating the Co₃O₄ film consisting of hollow nanorods having an average diameter of 70 mm and a length of 200 mm.

FIG. 12 is a graph showing the charge/discharge capacities of the Li/Co₃O₄ nanorod cell.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus, or process pathway. To avoid redundancy, detailed descriptions of much of the apparatus once described in relation to a figure is not repeated in the descriptions of subsequent figures, although such apparatus or process is labeled with the same reference numbers.

Lithium (Li) rechargeable batteries are widely used in applications which require high energy and power density with respect to portable electronics, communication devices, electric and hybrid vehicles, and other applications where the high energy and power density outputs are useful. The construction of lithium ion batteries are well known in the art as seen in reference to U.S. Pat. Nos. 7,060,390, 7,560,192, and 7,534,530 all of which are incorporated herein. I reference for all purposes. It has been found that providing anodes out of a nanostructured material offers enormous advantages in the resulting energy and power properties of the batteries.

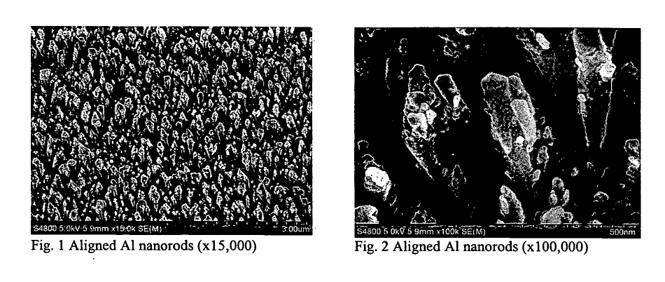

As described herein, an aligned metal nanostructure, such as free standing aluminum nanorods as seen in FIGS. 1 and 2, were grown directly on a titanium current collector using a vapor deposition, a lithium strip as the cathode, and a 1.0 M LiPF₆ in propylene carbonate and dimethyl carbonate was employed as the electrolyte. The resulting battery cell was assembled in a glove box and had a constant galvanic charge and discharge at 10 mA/g and demonstrated 1243 mAh/g reversible capacity. Such capacity is 4 times greater than the theoretical capacity of a carbon-lithium battery as currently used in the prior art having a 372 mAh/g.

It has been found that without having to use binders and conductive additives, the percentage of active materials within an anode is substantially increased and brings about fundamental improvements in the energy density of the anodes. Further, the active materials, Al nanorods, directly contact the current collector with good electron conductivity which leads to a higher power density.

While a lithium metal anode offers high theoretic capacity (3800 mAh/g) lithium metal cannot be used directly because of problems attributable to short circuits caused by lithium dendrite formation. Accordingly, most lithium-ion rechargeable batteries use Li intercalated carbon as the anode resulting in a theoretic capacity of 372 mAh/g (LiC₆). In order to achieve greater battery capacity, new anode materials which do not utilize carbon must be developed. As described herein, aligned metal nanorods from aluminum and other suitable metals, metal oxides and metal halides offer several advantages over conventional carbon based anodes. These advantages include:

1. High Electric Storage Capacity
Lithium ions will alloy with metal nanorods during charging. The lithium alloy anodes have higher theoretic capacity over the carbon anodes. For example, Li₆Al₄ and Li₂₁Si₆ have 2235 mAh/g and 4010 mAh/g gravimetrical capacity respectively. In addition, additional charge storage capacity may be found in inter-rod space resulting in a measurable capacity which exceeds the theoretic capacity.
The aligned nanorods can be made with metals such as Al, Si, Fe, Mg, Sn, Bi and metal oxides such as Co₃O₄, Fe₂O₃, MnO₂, SnO₂, Sb₂O₃, CuO, NiO, TiO₂, Cr₂O₃, ZnO₂, VO₂, V₂O₆, and MoO₃.

2. Long Cycle Life
The conventional alloying of lithium and other metals during charge changes the crystalline structure and causes a huge volume expansion such as a 300% volume expansion for Li₂₁Si₆. Similar levels of volume contraction will occur during discharge. The repeated volume expansion and contraction destroys anodes made by conventional method and significantly decreases the battery capacity. The aligned metal nanorods provided herein provide large inter-rod spaces that are capable of accommodating the volume expansion and preserve anode life while sustaining the original high capacity values of the battery.
Furthermore, the selection of the substrates (electrodes) plays a key role in sustaining the original high capacity. The substrate metals that can form the compounds or have solubility with the metals or metal oxides to be deposited on as the free-standing nanostructures will have strong adhesion and prevent the free-standing nanostructure from peel-off during multiple charge-discharge cycles, that contributes to the sustainable high capacity.

3. Low Manufacturing Cost
The aligned metal nanorods are directly grown on current collectors. Accordingly, they have excellent electrical conductivity and mechanical adhesion and thereby eliminate the use of binders and conductive additives currently employed in lithium-ion batteries. In addition to improved electrical conductivity, the steps of manufacturing the metal nanorods eliminate multiple prior art steps and result in a simplified and lower cost manufacturing process.

4. Improved Safety
Metal alloys used to form the nanorod were anodes do not react with the electrolyte as carbon containing anodes do. The prior art designs allow carbon to react with the solid electrolyte interface when batteries are overcharged or battery temperatures rise above 125° C. The inherent fire hazard caused by such thermal “runaway” reactions can be prevented by replacing the carbon anode material with metal anodes.

### Example 1

A thin film of aluminum nanorods were grown on a titanium substrate using vapor deposition as set forth on the accompanying FIGS. 1 and 2. The average diameter and length of the Al rods are 100 nanometers and 0.5 micrometers respectively. Electron dispersion spectroscopy analysis confirmed the nanorods are pure aluminum.

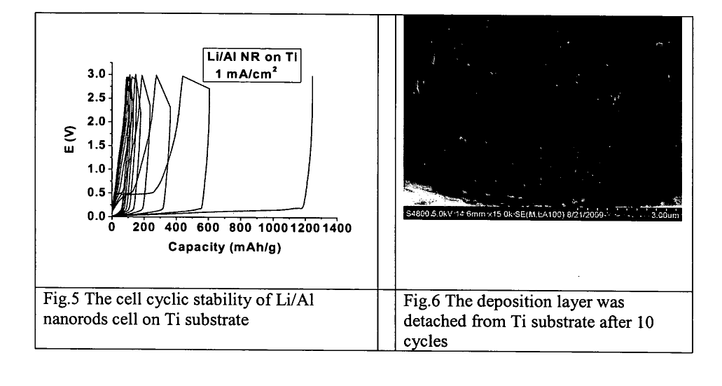

The lithium/aluminum nanorod cell, consisting of an aluminum nanorod anode and a lithium cathode and as referred to hereafter as Li/Al nanorods was tested for its electrochemical storage capacity and found to have a first discharge capacity of 1243 mAh/g from 3 volts to 0.01 volts at 10 mA/g. That discharge capacity is 4 times greater than the 372 mAh/g of carbon anodes and is illustrated in reference to FIG. 5.

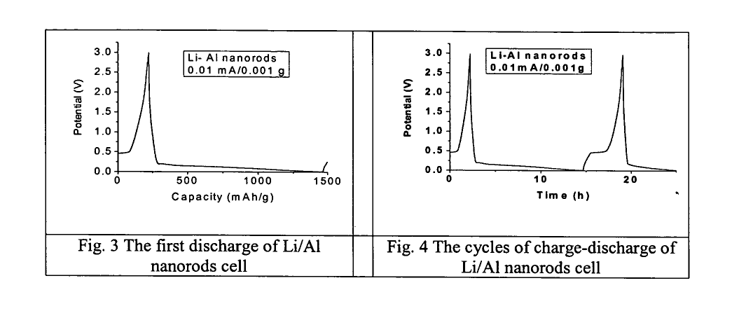

As seen in FIG. 3, the anode discharge capacity in a second discharging is 440 mAh/g. However, the discharge capacity was decreased to 100 mAh/g after only ten cycles (FIG. 5). It was found that the deposition layer of the Al nanorods was delaminated (FIG. 6) from the titanium substrate resulting in poor electric connection because of aluminum neither having solubility in titanium nor forming Al-Ti alloys.

### Example 2

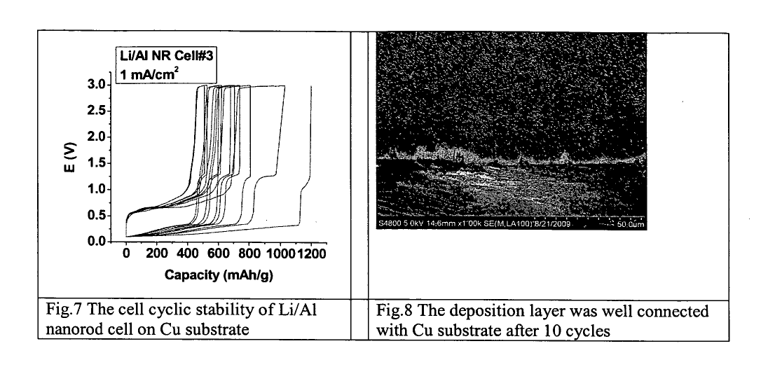

A thin film of aligned aluminum nanorods were grown on a copper substrate using vapor deposition as set forth on the above. The average diameter and length of the rods were measured at 100 nanometers and 0.5 micrometers respectively. The Li/Al nanorod cell was tested for its electrochemical storage capacity and found to have a first discharge capacity of 1243 mAh/g from 3 volts to 0.01 volts at 10 mA/g. The discharge capacity was maintained at 400 mAh/g after ten charge-discharge cycles (FIG. 7). The improvement of cyclic stability attributes to strong adhesion of aluminum and copper because Al can be dissolved in Cu and form alloys such as Li₉Al₄. The deposition layer well connected with copper substrate after ten cycles (FIG. 8).

### Example 3

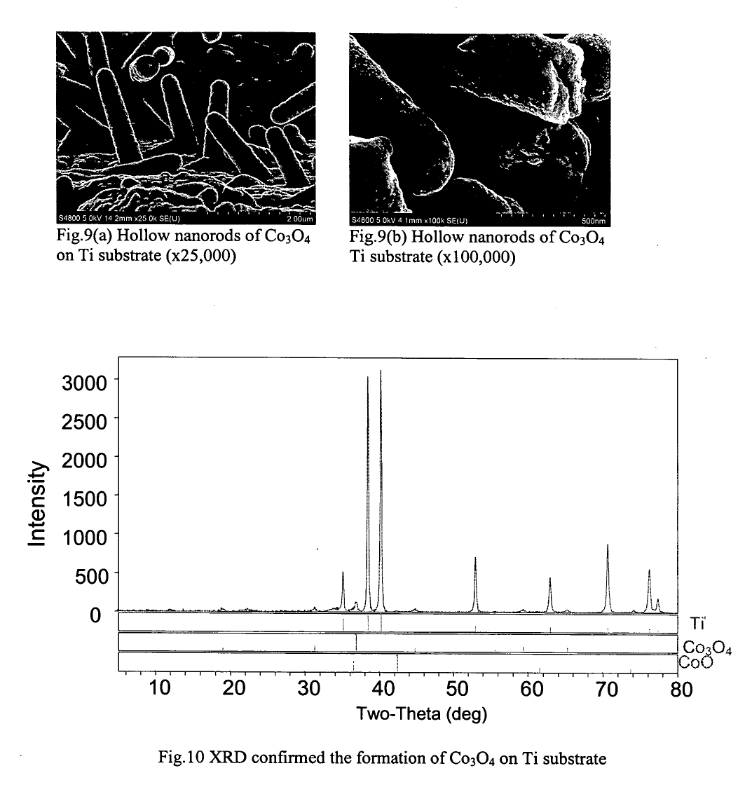

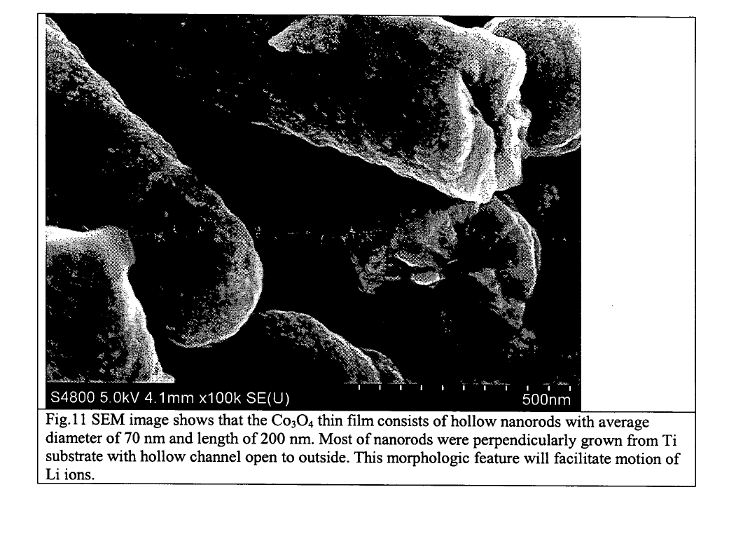

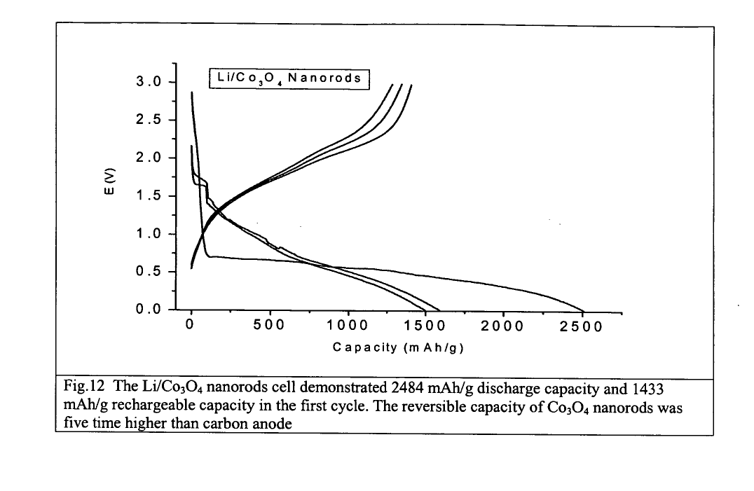

A thin film of aligned Co₃O₄ nanorods was grown on a titanium substrate as illustrated on FIGS. 9A and 9B. X-ray diffraction confirmed the Co₃O₄ formation (FIG. 10) and scanning electron microscopy reveals the Co₃O₄ formed a thin film consisting of hollow nanorods with an average diameter of 70 nanometers and a length of 200 nanometers (FIG. 11). The majority of the nanorods were perpendicularly grown from the titanium substrate with a hollow channel open to the exterior. This morphologic feature is believed to greatly facilitate the motion of lithium ions. The Li/Co₃O₄ nanorod cell demonstrated 2484 mAh/g discharge capacity from 2.7 V to 0.01 V and was recharged to 3 V with 1433 mAh/g rechargeable capacity in the first cycle. The reversible capacity of Li/Co₃O₄ nanorod cell was five time higher than carbon anode (FIG. 12).

While the examples described herein are related to anode nanostructures, it is recognized that similar nanostructures can be applied to cathode structures and which will provide additional benefits of increasing energy density and achieving lower fabrication costs, particularly with respect to thin film lithium-ion batteries.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention and claims as set forth herein. In addition, it should be understood that aspects of the various embodiments may be interchanged, both in whole, or in part. Therefore, the spirit and scope of the invention should not be limited to the description of the preferred versions contained therein.

What is claimed is:

1. The nanoscale architecture of anode materials and anode forming process for producing a lithium-ion battery, comprising forming aligned metal nanorods on a metallic substrate, such that the metal nanorods form a binder and additive free layer of metal having the thickness of at least 0.5 micrometers.

2. The process according to claim 1 wherein said metal nanorods have an average diameter of about at least 70 nanometers.

3. The process according to claim 1 wherein said metallic substrate is copper or other metals that can form the compounds or have solubility with the metals or metal oxides to be deposited on.

4. The process according to claim 1 wherein said metal nanorods are selected from the group of materials consisting of Al, Si, Fe, Mg, Sn, Bi and metal oxides such as Co₃O₄, Fe₂O₃, MnO₂, SnO₂, Sb₂O₃, CuO, NiO, TiO₂, Cr₂O₃, ZnO₂, VO₂, V₂O₅, and MoO₃.

5. The process according to claim 1 wherein said metal nanorod is aluminum and said metallic substrate is copper.

6. The process according to claim 1 wherein said metal nanorod is Co₃O₄.

7. The process according to claim 6 wherein said metallic substrate is titanium or other metals that can form the compounds or have solubility with the metals or metal oxides to be deposited on

8. The process according to claim 1 wherein said nanorods further define an opening along a terminal tip of said nanorod.
